(19) United States
(12) Patent Application Publication
(10) Pub. No.: US 2005/0001124 A1
(43) Pub. Date: Jan. 6, 2005

(54) Lamp mounting assembly

(76) Inventors: Mark R. Litke, Holland, MI (US); Edward H. Wysocki, Grand Rapids, MI (US); E. Fred Finke, Grand Haven, MI (US); Walter S. Hill, Muskegon, MI (US)

Correspondence Address: WARNER NORCROSS & JUDD LLP, 900 FIFTH THIRD CENTER, 111 LYON STREET, N.W., GRAND RAPIDS, MI, 49503-2487, US

(21) Appl. No.: 10/852,082

(22) Filed: May 24, 2004

Related U.S. Application Data
(60) Provisional application No. 60/472,858, filed on May 23, 2003.

(51) Int. Cl. F16B 45/00

(52) U.S. Cl. 248/305

(57) ABSTRACT

A lamp mounting assembly for mounting a lamp, such as a LED lamp assembly, to mounting structure, such as a support bar for a prisoner screen in an emergency vehicle. The lamp mounting assembly includes a universal primary bracket that is mountable in upright and inverted positions to permit mirror image lamp mounting on opposite sides of a vehicle. The lamp mounting assembly further includes a hook bracket that is mounted to the primary bracket. The hook bracket cooperates with the primary bracket to clamp the lamp mounting assembly to the desired mounting structure. The hook bracket mounts to the primary bracket when the primary bracket is in the upright or inverted positions. The lamp mounting assembly further includes a tower bracket that is pivotally mounted to the primary bracket. The tower bracket mounts to the primary bracket when the primary bracket is in the upright or inverted positions.

This non-provisional application claims priority from U.S. Provisional Application Ser. No. 60/472,858, filed May 23, 2003.

### BACKGROUND OF THE INVENTION

The present invention relates to lighting and more particularly to a mounting assembly for mounting a lamp assembly. The mounting assembly is particularly suited for use in mounting an LED lamp assembly within an emergency vehicle, for example, to a prisoner barrier.

There have been enormous strides over the last decade in the development of light emitting diodes (“LEDs”) and lighting systems incorporating LEDs. LEDs are typically more durable than incandescent and gas discharge lamps, and usually have a dramatically longer life span. As a result, LEDs are becoming increasingly popular in a wide variety of applications including in the field of emergency lighting, and particularly emergency vehicles lighting. LEDs are now commonly used as side flashing lamps in emergency vehicles, such as warning lamps in police cars.

There are a variety of conventional methods for mounting side lamps in an emergency vehicle. For example, the side lamps may be installed by drilling into the “B” pillar. This weakens the “B” pillar and requires significant installation effort. Other side lamps are installed through the use of custom brackets designed to fit existing mounting locations, such as the shoulder belt upper anchor point. This requires significant installation effort and, if not properly installed, may interfere with proper operation of the shoulder belt or other components sharing the same mounting location. In vehicles equipped with a prisoner screen such as police cars, the side lamp can be mounted directly to the structural support bars for the prisoner screen. In these applications, the side lamps are installed by drilling holes into the support bars and then fastening the LED lamp assembly using these holes. In addition to the significant installation effort, this can weaken the support bars and may void the warranty on the prisoner screen. Prisoner screens and the attendant hardware occupy space and limit the possible mounting locations. Accordingly, there is a need for highly adjustable lamp assembly mounting hardware that permits customized location of the lamp assembly.

In addition to the aforementioned drawbacks, most conventional mounting mechanisms suffer from a number of further shortcomings. For example, many conventional mounting mechanisms require the lamps to be mounted in a vertical position, even though most conventional LED lamps are configured to be mounted in a horizontal position. If an LED lamp is not properly oriented, the brightness and light distribution pattern can be significantly impaired and may no longer meet specification. Conventional mounting mechanism also do not have the ability to adjust the fore/aft or up/down angle of the lamp to ensure that is it parallel with the vehicle and the ground. In addition, there is typically no adjustment to ensure the lamps are parallel to the vehicle centerline in the fore/aft direction. Additionally, most conventional mounting mechanisms are difficult to remove at the end of the vehicle's life cycle, or leave undesirable holes in the vehicle or support bar once removed.

### SUMMARY OF THE INVENTION

The aforementioned problems are overcome by the present invention wherein a lamp mounting assembly is provided with a primary bracket and a hook bracket that can be mounted on opposite sides of a vehicle by clamping to the prisoner screen support bars. The primary bracket is generally symmetrical and is provided with upper and lower hooks that allow the bracket to be mounted in either an upright or inverted position, thereby permitting essentially mirror image installation on opposite sides of a vehicle.

In one embodiment, the lamp mounting assembly includes a tower bracket for pivotally mounting the lamp assembly to the primary bracket. The tower bracket preferably permits adjustment of the fore/aft and up/down angles of the lamp assembly. The pivoting connection between the primary bracket and tower bracket may include a fixed mounting point about which the tower bracket pivots and a second movable mounting point, such as a bolt fitted in an arcuate slot. The tower bracket may also be height adjustable. For example, the tower bracket may define a plurality of equally spaced mounting holes (or a single elongated slot) that permit the tower bracket to be mounted to the primary bracket at different heights. The tower bracket may further provide lateral adjustability. The tower bracket may define laterally extending slots for securing the lamp to the tower bracket. The lateral position of the lamp can be adjusted by varying the lamp's position along the slots.

The present invention provides a simple, inexpensive and effective mounting assembly for securing a lamp assembly to mounting locations, such as prisoner screen support bars, on opposite sides of a vehicle. The universal design permits lamp assemblies to be mounted to opposite sides of the vehicle in essentially mirror image configuration. This helps to provide consistent positioning and alignment of the lamp assembly and bracket on both sides of the vehicle. Also, the present invention does not require removal of any safety-related OEM installed hardware, such as the shoulder belt upper anchor point. The present invention is essentially universal, thereby eliminating the need for custom fabricated brackets.

The present invention is easily installed with common hand tools, thereby reducing installation cost and effort. Because the present invention mounts by clamping, it does not require drilling into the “B” pillar, support bar or any other component to install the lamp. The present invention allows retrofitting of vehicles with existing support structures, such as prisoner screen support bars.

The lamp mounting assembly of the present invention also provides a wide range of adjustability. For example, the mounting assembly is adjustable along vertical and horizontal planes, and is angle adjustable to provide proper fore/aft angular positioning. The mounting assembly may be used to mount lamps in a horizontal or vertical position to take advantage of the best clear area for best visibility. The mounting assembly can also be used to mount single or dual lamp assemblies without modification. The mounting assembly is easily removed and facilitates reuse of lamp assemblies at the end of a vehicles lifecycle.

These and other objects, advantages, and features of the invention will be readily understood and appreciated by reference to the detailed description of the preferred embodiment and the drawings.

### BRIEF DESCRIPTION OF THE DRAWINGS

FIG. 1a is an illustration of the lamp mounting assembly of the present invention.

FIG. 1b is a perspective view of the lamp mounting assembly mounted to the support of a prisoner screen.

FIG. 2a is a front elevational view of the primary bracket.

FIG. 2b is a top plan view of the primary bracket.

FIG. 2c is a right side elevational view of the primary bracket.

FIG. 3a is a front elevational view of the hook bracket.

FIG. 3b is a top plan view of the hook bracket.

FIG. 3c is a right side elevational view of the hook bracket.

FIG. 4a is a front elevational view of the tower bracket.

FIG. 4b is a top plan view of the tower bracket.

FIG. 4c is a right side elevational view of the tower bracket.

FIG. 5 is an exploded perspective view of an alternative embodiment of the present invention.

FIG. 6a is a front elevational view of the alternative left primary bracket.

FIG. 6b is a top plan view of the alternative left primary bracket.

FIG. 6c is a left side elevational view of the alternative left primary bracket.

FIG. 7a is a front elevational view of the alternative hook bracket.

FIG. 7b is a top plan view of the alternative hook bracket.

FIG. 7c is a right side elevational view of the alternative hook bracket.

FIG. 8a is a perspective view of the alternative tower bracket.

FIG. 8b is a front elevational view of the alternative tower bracket.

FIG. 8c is a right side elevational view of the alternative tower bracket.

### DETAILED DESCRIPTION OF THE PREFERRED EMBODIMENT

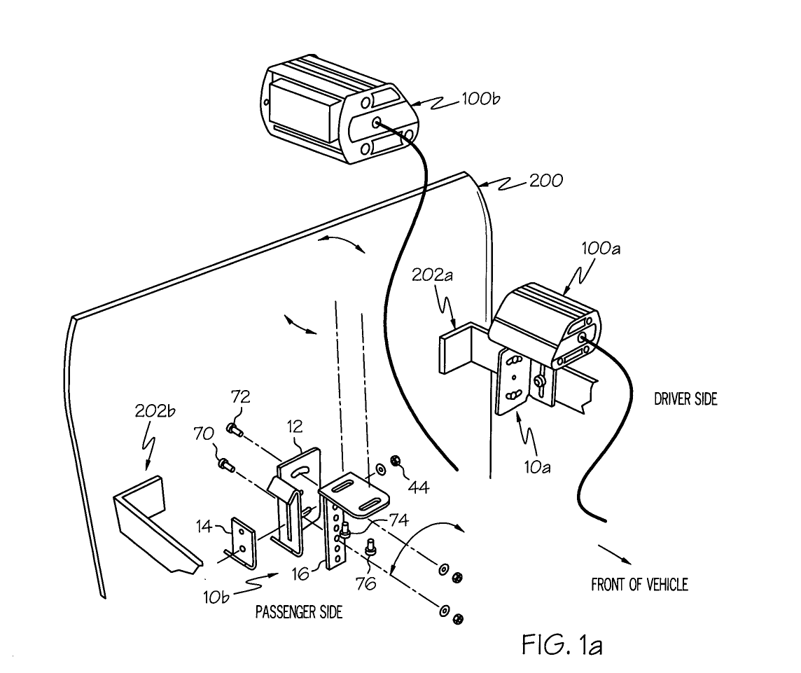

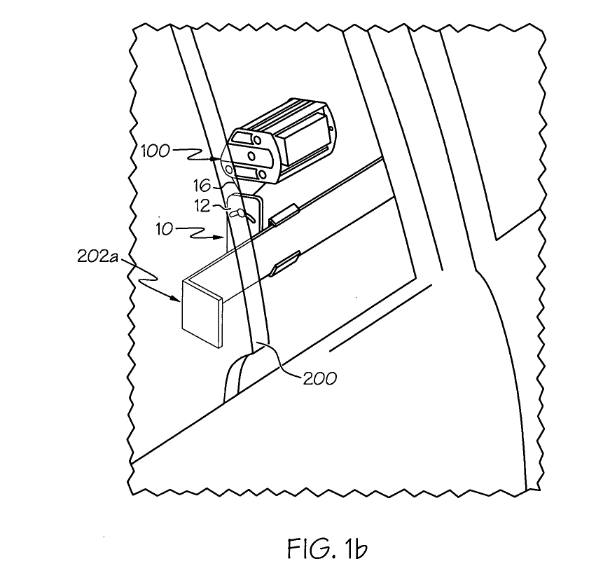

A lamp mounting assembly according to a preferred embodiment of the present invention is shown in FIG. 1a and generally designated 10. For purposes of disclosure, the present invention is illustrated in connection with the installation of side warning lamps 100a-b to the support bars 202a-b for a prisoner screen 200. The present invention may, however, be used to mount other types of lamp assemblies and to other mounting structures. For example, the present invention is well suited for use with both single and dual LED lamp assemblies.

FIG. 1a shows a side elevational view of a portion of a vehicle showing the general location of the lamp 100, as well as enlarged partially exploded perspective view showing one fully assembled lamp mounting assembly 10a and one exploded lamp mounting assembly 10b. As shown, each lamp mounting assembly 10 includes a primary bracket 12 and a hook bracket 14 that clamp about the corresponding support bar 202a-b. A tower bracket 16 is pivotally mounted to the primary bracket 12 to receive the lamp 100 and permit angular adjustment of the lamp 100 in the fore/aft, side-to-side and up/down directions.

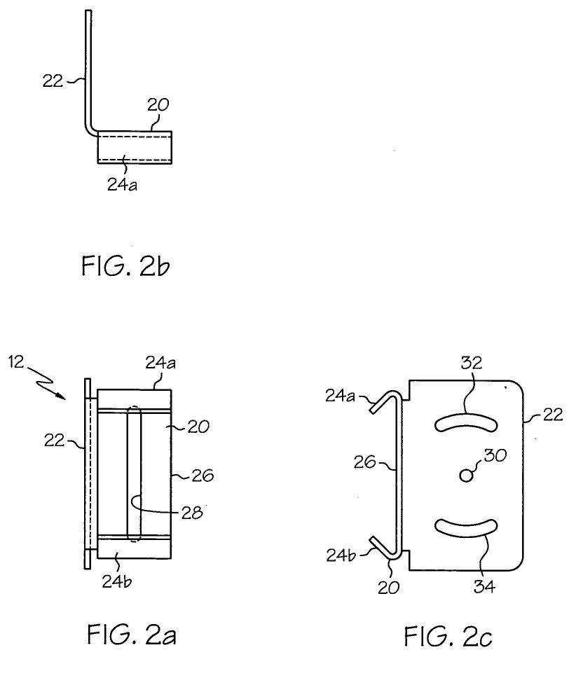

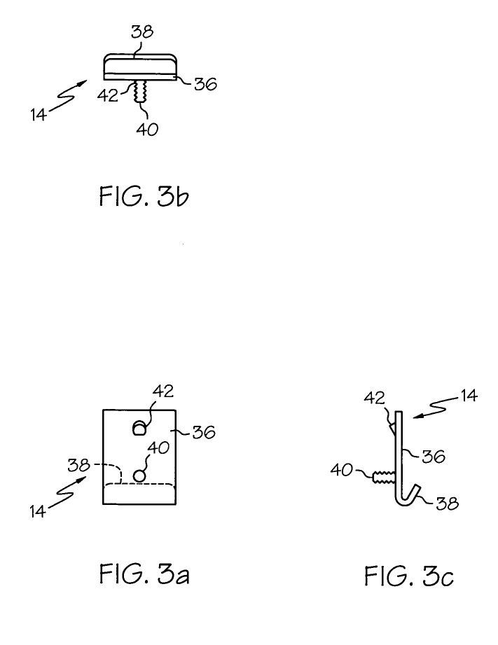

Referring now to FIGS. 2a-c, the primary bracket 12 is generally L-shaped having a base 20 and a support arm 22. The base 20 includes a pair of hooks 24a-b extending from opposite ends of a main body 26. The body 26 is configured so that the hooks 24a-b are spaced far enough apart to fit over the desired mounting structure, such as the support bars for a prisoner screen. In this embodiment, the hooks 24a-b extend from the top and bottom ends of the body 26 so that the lamp mounting assembly 10 can be mounted to the horizontally extending prisoner screen support bars. The hooks 24a-b preferably extend from the body 26 at an angle of approximately 45 degrees. This angle may vary depending in part on the thickness of the structure to which the lamp mounting assembly 10 is mounted. The illustrated hooks 24a-b permit mounting to a wide range of mounting structures. The size, shape and configuration of the hooks 24a-b may vary from application to application depending primarily of the configuration of the component to which it will be mounted. The body 26 also defines an elongated hook slot 28 for movably securing the hook bracket 14 (See also FIGS. 1a and 2a-c) to the primary bracket 12, for example, by a bolt 70. In this embodiment, the hook slot 28 is elongated in a substantially vertically direction to allow the hook bracket 14 to be moved toward and away from either of the hooks 24a-b as necessary to clamp onto a mounting structure. In alternative embodiments, the hook slot 28 may be elongated in other orientations to provide adjustability in other directions or it may be replaced by one or more circular holes to provide attachment of the hook bracket in one more fixed positions and to accommodate different widths of mounting structure.

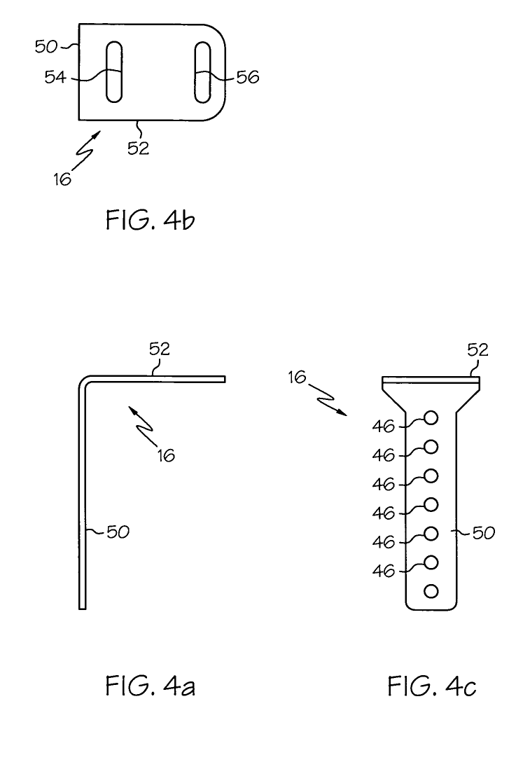

The support arm 22 extends from the body 26 to provide a mounting structure for the tower bracket 16 (See also FIGS. 4a-c). In the illustrated embodiment, the support arm 22 extends perpendicularly from a side edge of the body 26 in a generally vertical plane. The support arm 22 is integral with the body 26, but it may be separately fabricated and attached to the body 26, for example, by welding or fasteners. To facilitate mounting of the tower bracket 16, the support arm 22 of this embodiment defines a plurality of mounting openings, including a central mounting hole 30, an upper mounting slot 32 and a lower mounting slot 34. The central mounting hole 30 is configured to receive a screw, bolt, rivet or other fastening element. The central mounting hole 30 provides a fixed mounting point about which the tower bracket 16 can be pivoted to adjust the angle of the lamp 100. The upper mounting slot 32 and lower mounting slot 34 are arcuate slots having the central mounting hole 30 as their vertex. The slots 32 and 34 are configured to slidably receive a screw, bolt, rivet or other similar element to slidably interconnect the tower bracket 16 and the support arm 22. This sliding interconnection permits pivotal movement of the tower bracket 16 with respect to the primary bracket 12. This described mounting hole and slot configuration is merely exemplary. The mounting configuration may vary from application to application as desired. For example, the slots can be replace by one or more holes to permit the tower bracket 16 to be mounted in one or more fixed positions. In one embodiment, the primary bracket 12 is stamped from 12 gauge steel that is hot rolled, pickled and oiled, and that has a black powder coat finish.

The hook bracket 14 cooperates with one of the two hooks 24a-b on the primary bracket 12 to clamp the assembly 10 to a support structure. The hook bracket 14 generally includes a substantially planar body 36 and a hook 38 extending from one end of the body 36. In this embodiment, the hook 38 extends from the hook bracket 14 at an angle of approximately 30 degrees. The size, shape and configuration of the hook 38 will vary from application to application depending primarily on the characteristics of the component to which it is to be mounted. The hook bracket body 36 of this embodiment includes a threaded stud 40 and a tab 42. The stud 40 may be fixed to the body 36, for example, by welding, or it may be a separate screw or bolt. The stud 40 is disposed in a position to pass through the hook slot 28 in the primary bracket 12. A nut 44 or other fastener, such as a pall nut, may be fitted over the stud 40 to secure the hook bracket 14 to the primary bracket 12. The tab 42 protrudes from the hook bracket body 36 to fit into the hook slot 28. The tab 42 helps to ensure proper alignment between the hook bracket 14 and the primary bracket 12, and to resist rotation about the stud 40. The tab 42 may be formed by lancing or punching to raise the tab 42 from the remainder of the hook bracket body 36. Alternatively, the tab 42 can be replaced by a second stud or other projection. In some applications, the tab 42 can be eliminated altogether. In one embodiment, the hook bracket 14 is stamped from 12 gauge steel having a black powder coat finish.

The tower bracket 16 is pivotally mounted to the primary bracket 12, and more particularly to the support arm 22 of the primary bracket 12. In the illustrated embodiment, the tower bracket 16 is generally L-shaped having a first leg 50 that mounts to the primary bracket 12 and a second leg 52 that mounts to the lamp 100. The first leg 50 is integral with the second leg 52, but it may be separately fabricated and attached to the second leg 52, for example, by welding or fasteners. The first leg 50 defines a plurality of mounting holes 46 that permit the tower bracket 16 to be mounted to the primary bracket 12 at different heights. The mounting holes 46 are arranged to simultaneously align with the central mounting hole 30 and at least one of the two mounting slots 32 and 34. The size, shape and configuration of the mounting holes 46 may vary from application to application. For example, the plurality of mounting holes 46 can be replaced by a vertically elongated slot is some applications. In one alternative, the arcuate mounting slots can be defined in the tower bracket 16 and the plurality of mounting holes 46 can be defined in the primary bracket. The second leg 52 is configured to correspond with the mounting configuration of the lamp 100. In this embodiment, the second leg 52 defines a pair of elongated lamp mounting slots 54 and 56. The lamp mounting slots 54 and 56 are adapted to permit the lamp 100 to be secured to the tower bracket 16 by bolts, screws or other fasteners. The slots 54 and 56 permit adjustment of the lateral position of the lamp 100 on the bracket 16. The slots 54 and 56 can be replaced by the desired mounting configuration, for example, by one or more circular holes that permit the lamp 100 to be mounted in one or more fixed positions. In one embodiment, the tower bracket 16 is stamped from 12 gauge steel having a black powder coat finish.

The various components the lamp mounting assembly 10 can be manufactured using a wide variety of conventional techniques and apparatus. The components may be stamped (as noted above) or otherwise fabricated from appropriate metal stock, such as 12 gauge sheet steel. As an alternative, the various bracket components can be die cast or injection molded from other metal or thermoplastic materials.

Installation of the lamp mounting assembly 10 on the support bar 202 of a prisoner screen 200 will now be described in connection with FIG. 1. To install the lamp mounting assembly 10, the hook bracket 14 is fitted into position against the main body 26 of the primary bracket 12. More specifically, the stud 40 and tab 42 are fitted into the hook slot 28 in the main body 26 of the primary bracket 12. A nut 44 is preferably loosely fitted over the stud 40 to interlock the two parts while still permitting vertical movement of the hook bracket 14. The two pieces are then fitted over the prisoner screen support bar 202. The primary bracket 12 is positioned with one of its hooks 24a-b catching one edge of the support bar 202, preferably the upper hook 24a catching over the upper edge of the support bar 202. The hook bracket 14 is positioned with its hook 38 catching the other edge of the support bar 202, preferably catching under the lower edge of the support bar 202. In this way, one hook 24a-b of the primary bracket 12 and the hook 38 of the hook bracket 14 cooperate to entrap the prisoner screen support bar 202. Once the primary bracket 12 and hook bracket 14 are closed about the prisoner screen support bar 202, the nut 44 is tightened to hold the brackets in place. The tower bracket 16 can be mounted to the primary bracket 12 before or after the brackets are secured to the prisoner screen 200. In this embodiment, the tower bracket 16 is secured to the primary bracket 12 by a first bolt 70 extending through the central mounting hole 30 in the support arm 22 and one of the mounting holes 46 in the first leg 50 of the tower bracket 16, as well as by a second bolt 72 extending through one of the mounting slots 32 or 34 in the support arm 22 and one of the mounting holes 46 in the first leg 50 of the tower bracket 16. Once the tower bracket 16 is set to the desired angle, the bolts 70 and 72 are tightened. The lamp 100 is mounted to the second leg 52 of the tower bracket 16 by fasteners, for example, two bolts 74 and 76 extending upwardly through the slots 54 and 56 in the second leg 52 into corresponding threaded mounting holes (not shown) in the base of the lamp 100. In applications where the lamp 100 does not include threaded mounting holes, the bolts 74 and 76 can pass through mounting holes in the lamp 100 or in an attached lamp bracket (not shown) and be secured by corresponding nuts. The lamp 100 can be mounted to the tower bracket 16 before or after the brackets are mounted to prisoner screen 200. To mount a lamp 100 on the opposite side of the vehicle, for example, to the other prisoner screen support bar 202, the primary bracket 12 is inverted so that it is the mirror image of the first installed primary bracket 12. The remaining brackets are then installed consistent with the above description. Each remaining bracket is configured to mount to the primary bracket 12 when the primary bracket 12 is in either the upright or inverted positions. The described installation process is merely exemplary. The lamp mounting assembly 10 can be installed using a wide variety of alternative installation processes.

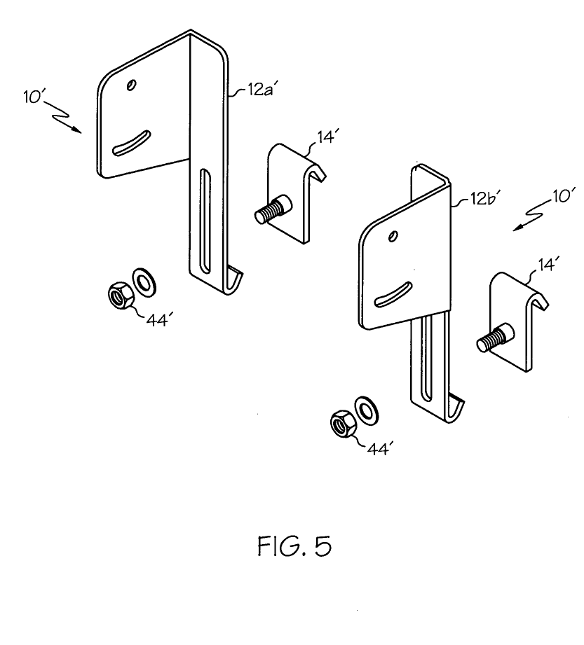

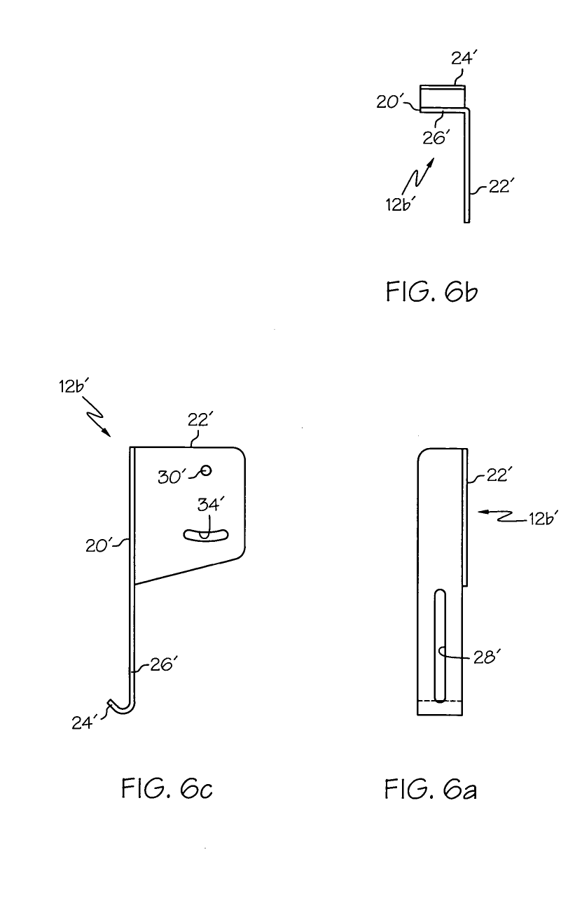

An alternative embodiment of the present invention is shown in FIGS. 5-8. In this embodiment, the universal primary bracket 12 is replaced by separate right and left primary brackets 12a-b′. As shown in FIG. 5, the right primary bracket 12a′ and left primary bracket 12b′ are essentially the mirror image of each other. For purposes of disclosure, the left primary bracket 12b′ will be described. Referring now to FIGS. 6a-c, the left primary bracket 12b′ generally includes a base 20′ and a support arm 22′. The base 20′ includes a main body 26′ and a hook 24′ extends from one end of the main body 26′, preferably its lower end in this embodiment. The body 20′ defines an elongated hook slot 28′ for movably securing the hook bracket 14′ to the primary bracket 12b′. The support arm 22′ provides an angle-adjustable mounting structure for the tower bracket 16′. As in the above described embodiment, the support arm 22′ defines a central mounting hole 30′. Because the primary bracket 12b′ is not intended for universal application (and hence is not intended for use in both upright and inverted positions), the support arm 22′ may define only a single arcuate mounting slot, preferably the lower mounting slot 34′ in this embodiment.

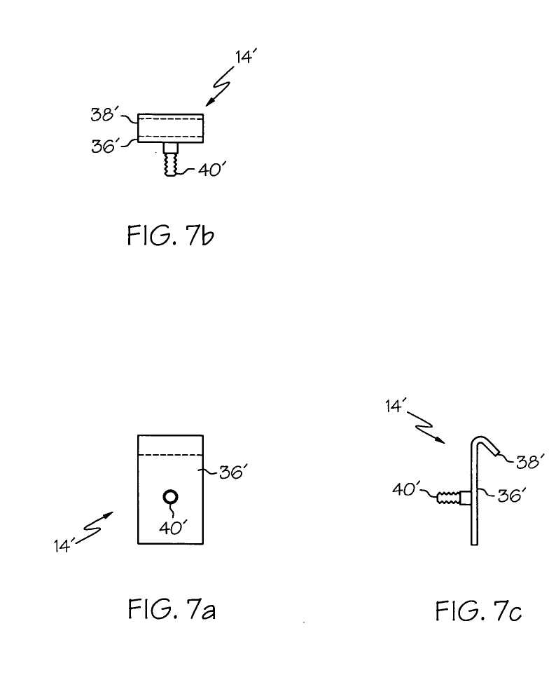

In this alternative embodiment, the lamp mounting assembly 10′ includes a hook bracket 14′ that cooperates with the primary bracket 12b′ to clamp about a mounting structure. The hook bracket 14′ is largely identical to the hook bracket 14 of the above described embodiment. As shown in FIGS. 7a-c, the hook bracket 14′ includes a body 36′ and a hook 38′. The body 36′ may include a threaded stud 40′ for mounting the hook bracket 14′ to the primary bracket 12b′. Although not shown, the hook bracket 14′ may also include a tab, such as tab 42.

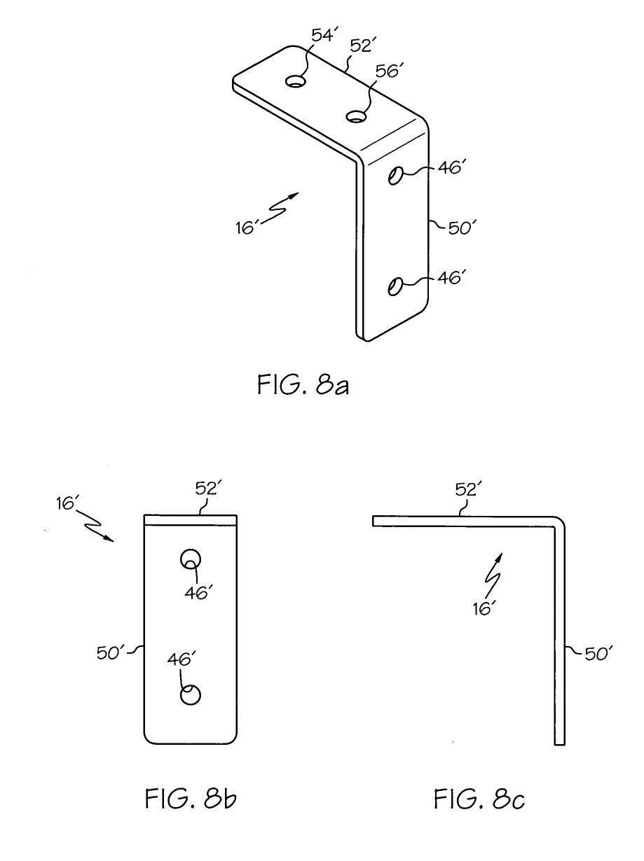

The alternative embodiment of FIGS. 5-8 also includes a tower bracket 16′ for adjustably securing the lamp 100 to the primary bracket 12b′. In this embodiment, a simpler tower bracket 16′ is provided. For example, as shown in FIGS. 8a-c, the tower bracket 16′ may be generally L-shaped having a first leg 50′ that mounts to the primary bracket 12b′ and a second leg 52′ that mounted to the lamp 100. In this embodiment, the first leg 50′ defines a pair of mounting holes 46′ that align with the central mounting hole 30′ and mounting slot 34′ of the primary bracket 12b′, and the second leg 52′ defines a pair of mounting holes 54′ and 56′ that are adapted to align with mounts in the lamp 100. Alternatively, the tower bracket 16′ may be essentially identical to the tower bracket 16 of the above described embodiment.

The above description is that of a preferred embodiment of the invention. Various alterations and changes can be made without departing from the spirit and broader aspects of the invention.

1. An assembly for mounting a lamp to a vehicle so that the lamp is viewable from the side of the vehicle, the vehicle having a prisoner screen, comprising a primary bracket and a hook bracket for attaching the lamp to the prisoner screen.

2. The assembly of claim 1 where the primary bracket is generally symmetrical.

3. The assembly of claim 2 where the primary bracket is provided with upper and lower hooks that allow the primary bracket to be mounted in either an upright or an inverted position.

4. The assembly of claim 3 further comprising a tower bracket for pivotally mounting the lamp to the primary bracket.

5. The assembly of claim 4 where the tower bracket is moveable to allow adjustment of the position of the lamp.

6. The assembly of claim 5 including a fixed mounting point about which the tower bracket pivots.

7. The assembly of claim 6 where the tower bracket is height adjustable.

8. The assembly of claim 7 where the tower bracket defines a plurality of equally spaced mounting holes so that the primary bracket may be mounted at different heights.

9. The assembly of claim 7 where the tower bracket includes an elongated slot so that the primary bracket may be mounted at different heights.

10. The assembly of claim 7 where the tower bracket defines a laterally extending slot for securing the lamp to the tower bracket.

11. The assembly of claim 10 where the lateral position of the lamp can be adjusted by moving the lamp within the laterally extending slot.

12. The assembly of claim 1 where the primary bracket is generally L-shaped.

13. The assembly of claim 12 where the primary bracket has a base and a support arm.

14. The assembly of claim 13 where the primary bracket is attached to a universal bracket.

15. The assembly of claim 1 where the primary bracket includes a right primary bracket and a left primary bracket.

16. The assembly of claim 1 where the primary bracket includes a base, a support arm, a main body and a hook.

17. The assembly of claim 16 further where the main body defines an elongated hook slot for moveably securing a hook bracket to the primary bracket.

18. The assembly of claim 17 further comprising a tower bracket for securing the lamp to the primary bracket.
